(19) United States
(12) Patent Application Publication
(10) Pub. No.: US 2011/0150420 A1
(43) Pub. Date: Jun. 23, 2011

(54) METHOD AND DEVICE FOR STORING MEDICAL DATA, METHOD AND DEVICE FOR VIEWING MEDICAL DATA, CORRESPONDING COMPUTER PROGRAM PRODUCTS, SIGNALS AND DATA MEDIUM

(75) Inventor: Emmanuel Cordonnier, Rennes (FR)

(73) Assignee: ETIAM S.A., Rennes (FR)

(21) Appl. No.: 13/003,746

(22) PCT Filed: Jul. 10, 2009
(86) PCT No.: PCT/EP2009/058855

§ 371 Date: Mar. 8, 2011

(30) Foreign Application Priority Data
Jul. 11, 2008 (FR) 0854752

(51) Int. Cl. H04N 9/80

(52) U.S. Cl. 386/241; 386/E09.011

(57) ABSTRACT

A method and apparatus are provided for storing medical data comprising at least one fixed image, termed a significant image, and a video sequence to which the significant image belongs. The method includes: tagging of at least one significant image in the video sequence acquired; determination of at least one item of time synchronization information, representative of the position of the significant image in the video sequence, as a function of a synchronization reference; generation of at least two medical imaging information objects, according to a predetermined standard, including a first object, termed the video object, and at least one second object, termed the significant image object; and storage and/or transmission of the medical imaging information objects and of the time synchronization information.

### CROSS-REFERENCE TO RELATED APPLICATIONS

This Application is a Section 371 National Stage Application of International Application No. PCT/EP2009/058855, filed Jul. 10, 2009, and published as WO 2010/004040 on Jan. 14, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of processing medical images and more specifically digital images.

The disclosure relates more specifically to techniques for processing and presenting “significant” images in a medical video sequence.

### BACKGROUND OF THE DISCLOSURE

Digital imaging solutions play a major role in improving diagnostics, treatment and health prevention for living beings, above all humans. The DICOM (Digital Imaging and COmmunications in Medicine”) standard, recognised as an international standard by the ISO (International Standards Organisation) is used to store and exchange such images in digital format.

The format of a DICOM image comprises a series of fields, some fields relating to medical traceability data (patient name, organ represented in image, exposure time, etc.), others relating to image acquisition characteristics (precise field, manufacturer model of unit used, acquisition date and time) and others to the pixels forming the image per se.

The DICOM format thus particularly makes it possible to keep a permanent link between an image, or sequence of images, and associated medical information. It is thus possible to compile a digital medical record for a patient, containing the patient's history, and particularly the medical investigations conducted.

Standardised digital images can be stored and exchanged via “PACS” (“Picture Archiving and Communication System”) systems, enabling people from various medical professions to dialogue on an investigation.

Initially defined for X-ray, thus fixed, images, the DICOM format is progressively opening up to images corresponding to other types of medical investigations, particularly in the field of surgery and endoscopy. These types of investigations use image sequences.

In such a sequence, the practitioner or operator can identify significant images, useful for confirming a diagnosis, for example.

It is thus necessary for PACS to be able to send image sequences and significant images.

A distinction is made between two types of image sequences:
“multi-frame” sequences, a succession of individual images acquired in full one by one, at optionally regular defined time intervals, and
video sequences, not consisting of images but a stream, the stored elements of said stream enabling the reconstruction of the each of the images, and viewing at the actual speed without jerking.

The advantage of a “multi-frame” sequence thus lies in that it is possible to easily extract a fixed image therefrom, the sequence per se consisting of fixed images. However, unlike a video sequence, a “multi-frame” sequence does not enable the inclusion of sound, which represents a major drawback since it deprives the user (i.e. the person viewing the sequence) of the sounds made by the patient and/or the comments of the doctor and/or the operator (i.e. identifying the significant images). Furthermore, a “multi-frame” sequence occupies much more memory than a video sequence.

An example embodiment of the invention applies more specifically to the cases in which video sequences are used.

The acquisition of a video sequence, if it is performed using digital video systems, and particularly if the format used is high-definition video format, requires a large storage volume and a high transmission capacity for PACS systems. In particularly, when the transmission speed is not sufficient, it is necessary, to successfully send video sequences, to degrade the quality thereof and thus that of the significant images obtained therefrom, or generate significant images prior to the degradation of the source video sequences and send same in addition to the video sequence.

In both cases, the problem thus arises of precise synchronisation between a video sequence and fixed images from said sequence.

A plurality of techniques are used at the present time for sending significant medical images, or fixed images, from a video sequence.

A distinction is particularly made between techniques based on the use of a standard format suitable for the medical sector (typically DICOM), handling fixed images and a video sequence independently, and techniques sometimes enabling time synchronisation of fixed images and a video sequence but not using a standardised format suitable for the medical imaging field.

These time synchronisation techniques conventionally use synchronisation within one second. This is sufficient for most purposes, as explained for example by the document published on the Internet “THE (Integrating the Healthcare Enterprise) IT Infrastructure (Information Technology Infrastructure)—Technical Framework” (http://www.ihe.net/Technical_Framework/upload/IHE_ITI_TF_{—}5-0_Vo11_FT_{—}2008-12-12.pdf in its recommendations, particularly page 45, paragraph 7—“Consistent Time”).

However, such a synchronisation is not suitable for all medical field applications. Indeed, if a video sequence has an acquisition frequency of 25 to 60 Hz for example, synchronisation within one second of a fixed image, extracted from said video sequence, and said video sequence, consists of a precision within 25 or 30 images. This is completely unacceptable in the context of a video-based medical investigation, in surgery for example, wherein it must be possible to access a particular image, and not an image selected at random from 25.

At the present time, in the systems suitable for the medical field, based on a standard format, and handling fixed images obtained from a video sequence and the video sequence per se independently, the processing of the video images by users, to locate a significant image (and account for the portion of the video preceding and/or following same for a detailed analysis, for example), is long and difficult.

Indeed, no mechanism enables them to locate a significant image directly when viewing the video sequence produced by the operator during acquisition. Therefore, most of the time, users only view fixed images, with no link with the video sequence from which they were obtained. For this reason, they lose the image acquisition context and thus lower the diagnostic potential thereof with respect to the investigation conducted.

In particular, a user viewing fixed images does not generally know when they are “located” in the sequence. Locating fixed images in the sequence thus requires a detailed analysis by the user of the entire video recording. This analysis may thus prove to be long and particularly hard as the interpretation of the investigation is not easy for the user.

Moreover, medical systems not based on a standard format limit exchanges between practitioners. Indeed, the processing of the images remains local to the acquisition system and is thus generally only accessible to the members of the department where the investigation was performed. In this way, for example, clinicians would not have access to images produced by surgeons.

Some systems not based on a standard format can nevertheless be used to convert acquired images and sequences into a standard format to be able to send same to another medical system. However, in this case, the conversion does not store specific information relating to the non-standard format.

Furthermore, the medical traceability data potentially present are also lost, giving rise to major risks in terms of patient security and quality of care. Indeed, this may give rise to an investigation attribution error to a patient or difficulties locating the other images (X-ray, scan, MRI) related to the patient in an image server, failing a correct identification for example.

### SUMMARY

Hereinafter in the document, the term “medical imaging information object” refers to the pair consisting of a digital image or video sequence and a set of supplementary data, encoded according to a standard medical field format, comprising at least one medical traceability data item.

An exemplary embodiment of the invention relates to a method for storing medical data comprising at least one fixed image, referred to as a significant image, and a video sequence consisting of a data stream for reconstructing a succession of images, said significant image corresponding to a specific time of said sequence, comprising the following steps:
acquisition of said video sequence;
tagging of at least one significant image in said acquired video sequence;
generation of at least one traceability data item associated with each of said significant images;
obtaining common time synchronisation reference means for said video sequence and each of said significant images;
determination of at least one item of time synchronisation information, representative of the exact position of said significant image in said video sequence, according to said synchronisation reference means;
generation of at least two medical imaging information objects, according to a predetermined standard, comprising:
   a first object, referred to as a video object, comprising at least said video sequence and a first set of data structured according to said standard comprising at least one medical traceability data item and representative data of said synchronisation reference means, and
   at least one second object, referred to as a significant image object, comprising one of said significant images and a second set of data structured according to said standard comprising at least said at least one medical traceability data item;
storage of said medical imaging information objects and said time synchronisation information, to enable, during subsequent viewing, the location in said video sequence of the exact image of said sequence corresponding to one of said significant images, according to said synchronisation reference means.

In this way, the video sequence object and said time synchronisation information refer unambiguously to the same synchronisation reference means. This may consist either of synchronisation reference means independent from each of said objects, such as a dedicated attribute of said standard, or either of the identification of said video sequence with the reference thereof in the significant image if said video sequence can be identified uniquely and overall by means of said standard.

These medical imaging information objects may be stored locally, in the device for the creation thereof, or in the associated storage means, such as a hard disk.

They may also be sent to a storage server and/or to remote restitution or viewing means, used for example by a specialised practitioner to analyse the information contained in said objects. These objects may then optionally be completed by other information and, if applicable, stored again and resent.

A video sequence consisting of a data stream for reconstructing a succession of images, a significant image corresponding to a specific time of the video sequence actually corresponds to a reconstructed image from said data stream.

In some embodiments of the invention, the second set of data also comprises at least one of said time synchronisation data items.

In this specific case, each significant image object thus contains the time synchronisation information associated with said significant image in respect of said video sequence.

It is thus easy, during subsequent viewing, to tag a position of a significant image in a video sequence, by means of the information contained in each of the objects, and thus study the time environment of said significant image. For example, this will enable easy access at the important point of an operation, using a significant image comprising an “exeresis” annotation.

Moreover, synchronisation information management is simplified and secure, in that the information is integrated in sets of standardised data (also comprising medical traceability data). There is thus no specific processing for the encoding and storage thereof, other than the definition of suitable fields in the standard. For their part, users do not need to use a special processing operation for the extraction and processing thereof.

For this reason, the solution proposed particularly offers the advantage of enabling successive processing of said image and said video sequence, such as backups, transfers, copies, between a plurality of operators without any risk of loss of context of said image in relation to said video sequence, said context remaining included in said image. In other words, the solution makes it possible to retain the medical value thereof.

In one particular embodiment of the invention, the significant image objects generated correspond to significant images selected by the investigator operator during or after the video sequence acquisition.

The selection of a significant image may in this case be performed by time tagging the key time associated with the acquisition. This tagging is performed in this case with sufficient precision to enable the exact tagging of said image in the sequence.

In this case, an embodiment of the invention proposes to create and/or process a link between video objects and/or significant image objects, so as to enable easy processing of both types of medical imaging information objects as if they consisted merely of one information item, and thus locate significant images in the sequence, or only view some parts of the sequence according to the times considered to be “key” by the user.

One alternative embodiment of the method envisages, in the medical imaging information objects generation step, the generation of at least one third object, referred to as a selection object, comprising a second set of data structured according to said standard, comprising an identifier of said video object and, for each of said significant image objects, an identifier of said significant image object and at least one of said corresponding time synchronisation information items.

In this case, the synchronisation information contained in the selection object may then be used to link a video sequence and the significant images contained therein.

This alternative embodiment offers the advantage of being applicable to the synchronisation of a video sequence and the significant images obtained therefrom even if they were generated by another device.

This embodiment also has the advantage of storing in two separate medical imaging information objects a significant image and the associated synchronisation information and thus limiting the processing of the significant image. Indeed, since the investigation procedure involves the responsibility of the practitioner, it is important to be able to guarantee the reliability of an image and particularly the absence of alteration.

According to exemplary embodiments of the invention, various time synchronisation mechanisms may be used.

For a video object, said representative data of the synchronisation reference means may include at least one item of information belonging to the group comprising:
a time reference source;
the description of a time distribution protocol;
a time pulse inserted in the video signal;
the date and time of the acquisition start and end times of said video sequence;
the effective duration of said video sequence;
the acquisition rate of said video sequence;
an identifier of said video sequence, identifying said video sequence according to said standard in a unique manner,
a feature of the multiplex frame corresponding to said video sequence (for example, the number of frame forming same, the shift between frames, etc.);
an identifier of the medical investigation for which said video sequence was acquired.

For a significant image object, said time synchronisation information has a selected precision, in relation to the acquisition rate of said video sequence, so as to enable the determination of the exact position of an image in said video sequence and may for example belong to the group comprising:
said time reference source;
the description of said time distribution protocol;
the identification of said video sequence according to said standard,
the indication of a frame number in the multiplex frame of said video sequence;
the index of said fixed image in said numbered frame;
the date and time corresponding to the acquisition of said fixed image;
an identifier of the medical investigation for which said significant image was acquired.

For example, the method may make it possible to synchronise a significant image object with a video object by means of the respective dating thereof, provided that the precision of said datings is sufficient to enable the description of a single image in said video sequence. The precision of the dating should be at least in the region of one tenth of a second.

For example, the indication of a frame number in the multiplex frame of said video sequence makes it possible to identify the specific time of the video sequence corresponding to the significant image.

According to one particular embodiment, the method may particularly comprise the following steps:
inclusion in the video object of time indications corresponding to the selection of significant fixed images;
identification in the significant image object of the video sequence from which said significant image is obtained;
use of said time indications to synchronise said two medical imaging objects during subsequent restitution.

According to one particular embodiment of the invention, said acquisition and tagging steps of said significant image are applied simultaneously.

Depending on the cases, the medical imaging information objects generated do not necessarily have the same definition (image size) or strict time correspondence (in the event of time sub-sampling of the video for example).

In this case, the use of said common synchronisation reference means and time synchronisation information associated with said objects will enable the synchronisation of said objects together.

In this way, in one embodiment of the invention, the method may comprise a compression step delivering a compressed video object with a lower definition quality than the initial quality of said acquired video sequence.

This thus makes it possible to minimise the size of the video sequence. Indeed, the storage volume of a video sequence, particularly in HD format, is a critical factor for PACS systems.

In further embodiments, said significant image objects may be generated with an equivalent definition quality to the initial quality of said acquired video sequence.

An embodiment of the invention thus offers optimal image quality for the significant parts of the investigation, thus favouring the subsequent interpretation thereof.

In some particular embodiments of the invention, the method is suitable for ensuring compatibility with a standard medical imaging format to retain medical traceability, for example DICOM format encoding.

In this case, according to a particular embodiment of the invention, said synchronisation reference means may for example be based on the DICOM “Synchronisation Frame of Reference UID” attribute and/or on the unique and overall identification of the video sequence by means of a recording method and said at least one generated selection object may for example be a “Key Object Selection” type DICOM object (in addition to the video and significant image objects).

According to exemplary embodiments of the invention, the invention may comprise an additional synchronisation step of at least one of said medical imaging information objects with another medical imaging information object from another acquisition source than said video sequence.

In this way, for example, the method envisages the possibility of a restitution, in addition to the video sequence and significant images from said video sequence, of the comments by the doctor who conducted the medical investigation. It may consist of a comment relating to the entire video sequence or the interpretation of one of the significant images.

A further example of application consists of the annotation of a significant image, and/or the addition of graphic items (dot, circle, arrows, etc.) to a significant image.

An embodiment of the invention also relates to a device for storing medical data using the method described above.

Such a device particularly comprises the following means:
acquisition means of said video sequence;
means for tagging at least one significant image in said acquired video sequence;
means for generating at least one traceability data item associated with each of said significant images;
means for obtaining a common time synchronisation reference means for said video sequence and each of said significant images;
means for determining at least one item of time synchronisation information, representative of the exact position of said significant image in said video sequence, according to said synchronisation reference means;

means for generating at least two medical imaging information objects, according to a predetermined standard, comprising:
a first object, referred to as a video object, comprising at least said video sequence and a first set of data structured according to said standard comprising at least one medical traceability data items and representative data of said synchronisation reference means, and
at least one second object, referred to as a significant image object, comprising one of said significant images and a second set of data structured according to said standard comprising at least said at least one medical traceability data item;
means for storing said medical imaging information objects and said time synchronisation information, to enable, during subsequent viewing, the location in said video sequence of the exact image of said sequence corresponding to one of said significant images, according to said synchronisation reference means.

In some embodiments, the video sequence acquisition means are digital means. In further embodiments, they may comprise (additionally or alternatively) analogue video sequence acquisition means and/or analogue/digital conversion means.

According to the embodiments, the means for tagging at least one significant image may be diverse. For example, they may consist of a suitable MMI interface, for example in the form of a trigger, button, pedal, touch screen, voice recognition system, etc.

An embodiment of the invention also relates to a method for viewing medical data comprising at least one video sequence consisting of a data stream for reconstructing a succession of images, said significant image corresponding to a specific time of said sequence, stored, according to the method described above, in the form of a first object, referred to as a video object, and at least one second object, referred to as a significant image object, and comprising at least one medical traceability data item.

Such a viewing method comprises the following steps:
playback of said video object, to obtain said video sequence and a first set of data structured according to said standard comprising at least one medical traceability data item and representative data of synchronisation reference means;
playback of said at least one significant object, to obtain a significant image and a second set of data structured according to said standard comprising at least said at least one medical traceability data item;
obtaining at least one item of time synchronisation data relating to said significant image;
identification of the exact position of said significant image in said video sequence using said item of synchronisation information and said synchronisation reference means;
selection of a portion of said video sequence, comprising at least one image near said significant image, according to said traceability data of said second object;
restitution of said significant image and said portion of said video sequence.

According to the object generation modes, as described above, the time synchronisation information is extracted from the second significant image objects, or a third selection object.

The selection of a portion of video sequence to be reproduced is dependent on at least one medical traceability data item of the second object. The medical traceability data associated with the second object may particularly comprise data representing a comment by the doctor, for example acquired either using a voice recognition device and stored in text form, or defined by selecting a specific code.

For example, a representative image may be accompanied by a comment indicating the start of incision and, in this case, the video sequence portion selected will start with an image near the significant image. On the other hand, the selection may lead to a video sequence portion ending with an image near the significant image if the comment by the doctor indicates, in the case of an endoscopic investigation for example, the end of the investigation of a critical area.

The restitution of a significant image and a portion of the video sequence may be done simultaneously, in two windows and/or on two screens, or in alternation, for example according to a switching command between objects.

In this way, the viewing of the objects obtained previously processes synchronisation information inserted in the video objects and in the significant image objects. This provides rapid and effective means, enabling a practitioner to determine the context, in the form of a portion of the video sequences, of a significant image being studied.

This approach does not require additional data other than those inserted in the objects, in a format suitable for direct interpretation by the viewing means.

According to particular feature of an embodiment of the invention, said restitution step also comprises the restitution of said at least one medical traceability data item. This may consist for example of a comment by the doctor on the medical investigation or a detail relating to a significant image in voice, text or graphic form.

The restitution step may include, at least in some embodiments, criteria defined by configuration or manually belonging to the group comprising:
viewing of all the significant images in said acquired video sequence;
viewing of each significant image with which a specific medical traceability data item is associated,
selection of the significant images to be viewed by the user;
dynamic restitution of said portion of said video sequence according to the time tagging thereof with respect to said significant image.

According to exemplary embodiments of the invention, the dynamic restitution step uses at least one criterion defined by configuration or manually belonging to the group comprising:
duration of said portion of said video sequence;
time interval between the start and/or end of said portion of said video sequence and the time tagging associated with said significant image;
memory size of said portion of said video sequence;
spatial resolution of said portion of said video sequence.

In some particular embodiments, the method may envisage the automatic generation of a portion of said video sequence wherein the start and end are defined as according to the time reference of a significant image object.

In some embodiments of the invention, the restitution step may also make it possible to display a video sequence at the fixed images associated therewith simultaneously.

The restitution of medical imaging information objects may for example consist of viewing via a medical imaging work station or transmission to another device, such an image viewing computer application.

An embodiment of the invention also relates to a device for viewing medical data using the viewing method described above. Such a device particularly comprises the following means:
means for playing back said video object, to obtain said video sequence and a first set of data structured according to said standard comprising at least one medical traceability data item and representative data of said synchronisation reference means;
means for playing back at least one significant object, to obtain a significant image and a second set of data structured according to said standard comprising at least said at least one medical traceability data item;
means for obtaining at least one item of time synchronisation data relating to said significant image;
means for identifying the exact position of said significant image in said video sequence using said item of synchronisation information and said synchronisation reference means;
means for selecting a portion of said video sequence, comprising at least one image near said significant image, according to said traceability data of said second object;
means for the restitution of said significant image and said portion of said video sequence.

Such a viewing device is for example a medical imaging workstation or another device hosting an image viewing computer application.

An embodiment of the invention also relates to a computer program product downloadable from a communication network and/or saved on a medium suitable for reading by a computer and/or execution by a processor, comprising program code instructions for the use of the storage or viewing method described above when said program is run on a computer.

An embodiment of the invention also relates to a signal, representative of a data stream representing a video object, generated according to the storage method described above, comprising a video sequence consisting of a data stream for reconstructing a succession of images, and a first set of data structured according to a predetermined standard comprising at least one medical traceability data item and representative data of said synchronisation reference means.

According to some embodiments of the invention, said representative data of said synchronisation reference means include at least one item of information belonging to the group comprising:
a time reference source;
the description of a time distribution protocol;
a time pulse inserted in the video signal;
the date and time of the acquisition start and end times of said video sequence;
the effective duration of said video sequence;
the acquisition rate of said video sequence;
an identifier of said video sequence, identifying said video sequence according to said standard in a unique manner,
a feature of the multiplex frame corresponding to said video sequence;
an identifier of the medical investigation for which said video sequence was acquired.

An embodiment of the invention also relates to a signal, representative of a data stream representing a significant image object, generated according to the storage method described above, comprising at least one significant image corresponding to a specific time of a video sequence consisting of a data stream for reconstructing a succession of images and a second set of data structured according to a predetermined standard, comprising at least at least one medical traceability data item and at least one item of time synchronisation information representative of the exact position of the significant image in said video sequence, according to common time synchronisation reference means for said video sequence and said significant image.

According to some embodiments of the invention, said time synchronisation information has a selected precision, in relation to the acquisition rate of said video sequence, so as to enable the determination of the exact position of an image in said video sequence and belongs to the group comprising:
said time reference source;
the description of said time distribution protocol;
the identification of said video sequence according to said standard,
the indication of a frame number in the multiplex frame of said video sequence;
the index of said fixed image in said numbered frame;
the date and time corresponding to the acquisition of said fixed image;
an identifier of the medical investigation for which said significant image was acquired.

An embodiment of the invention also relates to a signal, representative of a data stream characterised in that it comprises a selection object generated according to the storage method described above, comprising a set of data structured according to a predetermined standard, comprising at least one medical traceability data item and the identifier of said video object consisting of a data stream for reconstructing a succession of images, at least one identifier of a significant image corresponding to a specific time of said video sequence and at least one item of time synchronisation information representative of the exact position of the significant image in said video sequence, according to common time synchronisation reference means for said video sequence and said significant image.

Finally, an embodiment of the invention relates to a data medium containing at least one of the signals described above.

### BRIEF DESCRIPTION OF THE DRAWINGS

Further features and advantages will emerge more clearly on reading the following description of a preferential embodiment, given merely as an illustrative and non-limitative example, and the appended figures, wherein:

FIG. 1 represents a functional block diagram of the storage method and viewing method according to a particular embodiment of the invention;

FIG. 2 illustrates the steps of the storage method according to an embodiment of the invention;

FIG. 3, based on the block diagram represented in FIG. 1, illustrates the structure of two medical imaging information objects, corresponding to a video sequence and a fixed image respectively;

FIG. 4 illustrates the steps of the viewing method according to an embodiment of the invention;

FIG. 5, based on the block diagram represented in FIG. 1, describes an example of viewing according to an embodiment of the invention.

### DETAILED DESCRIPTION OF ILLUSTRATIVE EMBODIMENTS

### 1. Summary of General Principle of an Embodiment of the Invention

The general principle of the invention thus consists of creating and operating a mechanism for synchronising fixed medical images with the video sequence(s) from which they are obtained, in encoding compatible with a standard format, for example DICOM type.

Two embodiments are described hereinafter. In the first embodiment, two object structures are defined, comprising, in addition to the usual data, synchronisation information. In the second embodiment, at least one part of the synchronisation information is inserted in a third object, referred to as a selection object.

### 2. First Particular Embodiment

Hereinafter, an example of an embodiment of the invention suitable for use by a hospital for functional investigations will be described.

For example, a practitioner needs to conduct an endoscopic investigation on a patient and send the results of this investigation, the conclusions and any anomalies detected to the doctor who prescribed the endoscopy.

It may also consist of an ultrasonography, scan, MRI, Doppler, 3D X-ray or any other medical investigation generating a video sequence, whether it is analogue or digital.

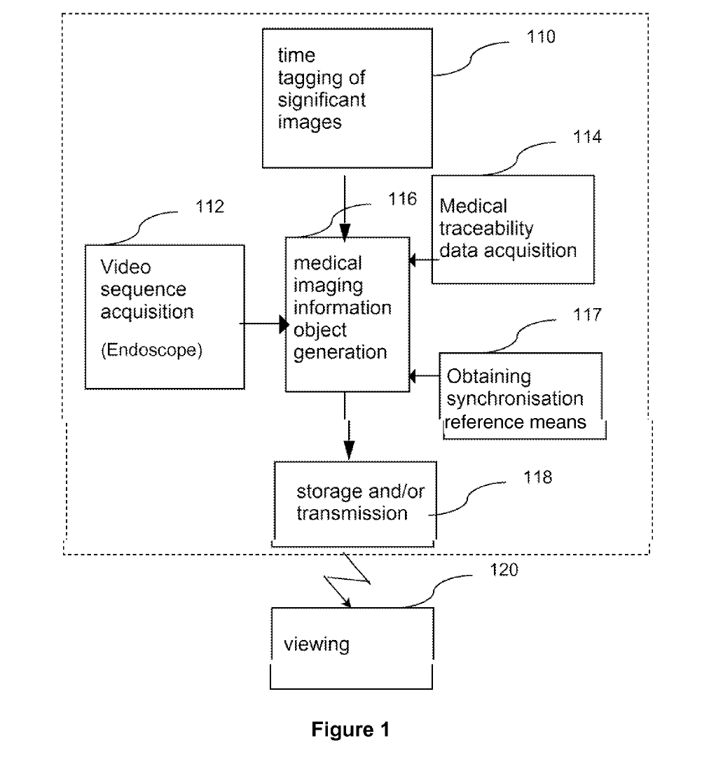

With reference to FIG. 1, a particular embodiment of the method is represented.

In the particular embodiment of the invention represented, means for generating medical imaging information objects 116, suitable for receiving information from a plurality of sources described hereinafter are described.

Firstly, the means 116 receive data from means for generating medical traceability data 114. These means for generating medical traceability data 114 may comprise for example means for reading a barcode, an electronic card or an RFID chip and/or means for entering or selecting data associated with the patient, such as the identity or social security number thereof for example, or data relating to the practitioner and/or the characteristics of the investigation (date and time, location of investigation, type of investigation for example, etc.) and/or the devices used (reference, serial number, date of most recent device check for example, etc.) and/or any other medical data. The means for generating medical traceability data 114 may also comprise means for receiving electronic data from another medical system.

Secondly, the particular embodiment described herein envisages video sequence acquisition means 112, an endoscope in the example shown, suitable for acquiring video streams, in high definition for example, and sending same to the means for generating medical imaging information objects 116.

The method also envisages means for obtaining a time synchronisation reference means 117 and sending said reference means to the significant image time tagging means 110.

Finally, the means for generating medical imaging information objects 116 are also suitable for receiving time indications from significant image time tagging means 110. In the particular embodiment described herein, the time tagging means 110 are suitable for enabling the practitioner to select, or tag, the key times of the acquisition, such as the start and end times and the times corresponding to important, or significant, images of the investigation.

According to the embodiments, this selection may be performed easily by means of various means such as for example a trigger, button for actuation, pedal, touch screen, or a voice recognition system.

The means for generating medical imaging information objects 116 are suitable for generating from a video sequence, at least one medical imaging data item and a time indication, at least one video object type medical imaging information object and at least one significant image object type medical imaging information object.

In one particular embodiment of the invention, the means for generating the medical traceability data 114 are also suitable for enabling the acquisition of medical data, such as for example a comment by the doctor, during the acquisition by the video sequence acquisition means 112 or during the selection by the significant image time tagging means 110, and sending same to said means for generating medical imaging information objects 116.

According to the embodiments, the means for generating medical imaging information objects 116 further comprise means for reducing the quality of the video sequence contained in a video type medical imaging information object.

In this way, according to an embodiment of the invention, the means for generating medical imaging information objects 116 may for example be suitable for generating, from a video sequence in HD (high definition) format, a video type medical imaging information object, wherein the video sequence is reduced from HD format to a lower definition quality video format, and a significant image type medical imaging information object in HD format.

In one advantageous embodiment, the generation means 116 are suitable for generating medical imaging information objects in compliance with a medical imaging standard. For example, it may consist of DICOM format.

The generation means 116 are suitable for transferring the generated objects to a storage device 118. This device 118 is suitable for storing medical imaging information objects. In some particular embodiments of the invention, it is also suitable for sending same to another local or remote device. This may for example consist of a viewing device or other storage device.

The method according to an embodiment of the invention also uses a device for viewing medical imaging information objects 120.

In the particular case described herein, the viewing device 120 comprises means for viewing medical images and/or video sequences and suitable for receiving video or significant image type medical imaging information objects and for showing the video sequence linked with the significant images obtained therefrom.

The viewing device 120 may for example comprise means for classifying the significant images defined according to relevance. This classification may for example be performed locally by a surgeon after the investigation or be based, manually or automatically, on specific medical traceability data relating to the significant images, such as for example a comment or the allocation of a code by the doctor conducting the investigation.

According to some particular embodiments of the invention, the viewing device 120 may be suitable for displaying a synoptic of the video sequence indicating the times corresponding to the associated fixed images.

The viewing device 120 may also comprise means for configuring the video sub-sequences to be reproduced. The proposed configuration means may for example comprise a time interval before and/or after each key time corresponding to a significant image, the definition of a fixed or maximum size and/or time, and/or use medical traceability data associated with said images.

Furthermore, the viewing device 120 may make it possible to configure rules for displaying significant images when viewing the video sequence, such as for example the display of the significant image nearest the current time or the significant image immediately following the current time, or the classification of images according to the relevance thereof.

The viewing device 120 may also comprise means enabling the user to select at least one fixed image for viewing an associated sub-sequence. The restitution device may in this case comprise means for calculating at least one sub-sequence. This calculation may for example be dependent on configured data and/or the key time corresponding to said significant image.

Finally, the viewing device 120 may further comprise means for the restitution of other data received synchronised with the medical imaging information objects such as sound (comments by surgeon, noises from investigation, etc.) for example. The restitution of these other data may be done at a different speed to that of the video sequence.

They may also consist of data associated with a significant image and shown in conjunction therewith, such as text or graphic annotations of the image. For example, a text annotation may be generated automatically and associated with the significant image by means of voice recognition of key words uttered by the doctor.

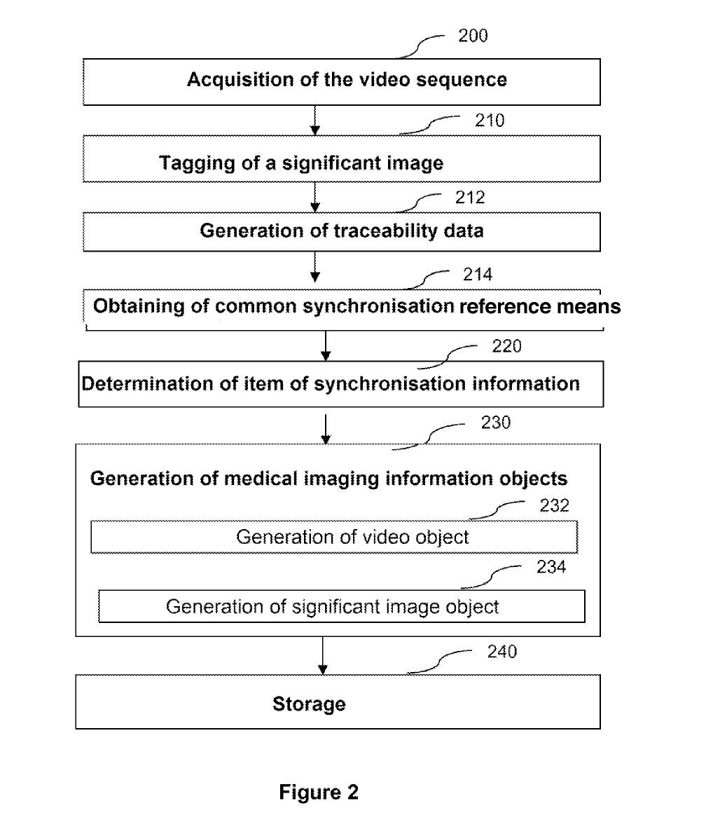

The storage method according to an embodiment of the invention is described, illustrated by FIG. 2.

A first step 200 consists of the acquisition of the video sequence. This acquisition is performed, in the particular embodiment described herein, simultaneously with the medical investigation.

This step is followed by a step 210 for tagging at least one significant image.

In the embodiment described herein, both steps are consecutive. For example, after the investigation, the practitioner views the recorded video sequence to select the significant images therefrom.

In further embodiments, the steps 200 and 210 may be performed simultaneously, with the practitioner selecting the significant images during the investigation.

Particular embodiments also enable the practitioner to perform step 210 once again after the investigation to add new significant images.

The tagging of a significant image is followed by a step for generating traceability data 212, associated with said significant image. According to exemplary embodiments of the invention, the data may consist of at least one general medical traceability data item for the investigation and/or at least specific medical traceability data item for said one significant image.

The method according to an embodiment of the invention further envisages a step 214 for obtaining a time synchronisation reference means, common for said video sequence and said significant image, and a step 220 for determining an item of time synchronisation information characterising the exact position of the significant image in the video sequence according to said reference means. The selected synchronisation reference means and the associated synchronisation information are dependent on the embodiment of the invention. They should enable the unique identification of the image selected in the video sequence.

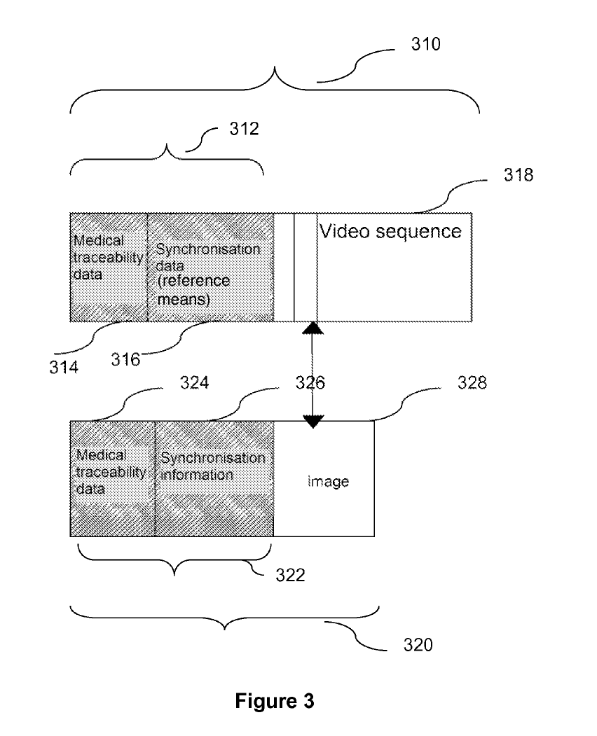

This step 220 is followed by a step 230 for generating at least two medical imaging information objects. This generation step 230 comprises a sub-step 232 for generating a video object type medical imaging information object and a sub-step 234 for generating a significant image type medical imaging information object. The structure of both types of medical imaging information objects is described hereinafter with reference to FIG. 3.

Finally, the method envisages a step 240 for storing the medical imaging information objects generated.

With reference to FIG. 3, the structure of a video object type medical imaging information object 310 and a significant image type medical imaging information object 320 are presented, the significant image being obtained from the video sequence, in a particular embodiment of the method according to the invention.

In the particular embodiment represented, a video object 310 or significant image 320 type medical imaging information object comprises two parts.

In the example illustrated in FIG. 3, the first part of a video object type medical imaging information object 310 is a header 312. This header particularly comprises at least one medical traceability data item 314 and at least one data item 316 representative of synchronisation reference means for synchronisation between the video sequence 318 and a significant image 328.

In the example illustrated in FIG. 3, the first part of a significant image object type medical imaging information object 320 is a header 322. This header particularly comprises at least one medical traceability data item 324 and at least one data item 326 representative of synchronisation reference means for synchronisation between the significant image 328 and the associated video sequence 318.

In a particular embodiment of the invention, the structure of the medical information imaging objects complies with a medical imaging standard. In particular, according to a particularly advantageous embodiment, the first part may consist of DICOM attributes.

According to the embodiments, the data for synchronisation between the sequence and fixed image may be different. They may consist of attributes already present in the standard, such as DICOM “AcquisitionDateTime”, “AcquisitionDate”, “ContentDate”, AcquisitionTime”, “ContentTime” attributes, for example.

They may also consist of new attributes, forming an extension of the standard format.

The synchronisation mechanisms used are dependent on the embodiments. They may consist for example of the date and/or time of the significant images with reference to the original video sequence start date and/or time, and/or the indication of a time resource source and/or the description of a time distribution protocol.

The synchronisation reference means may for example be defined by the DICOM “Synchronisation Frame of reference IUD” attribute. It may also be defined by the attribution, by means of a method for saving a unique overall identifier for the acquired video sequence.

Further synchronisation mechanisms may also be based on further synchronisation data.

For example, for a video type object, they may consist of the effective video sequence time, the acquisition rate thereof, a feature of the corresponding multiplex frame such as the number of frames contained or the shift between the frames.

For a significant image type object, it may consist for example of the indication of a frame number in the multiplex frame of the video sequence and/or the index of the significant image in the numbered frame, thus enabling the identification of the specific time of the video sequence corresponding to the significant image.

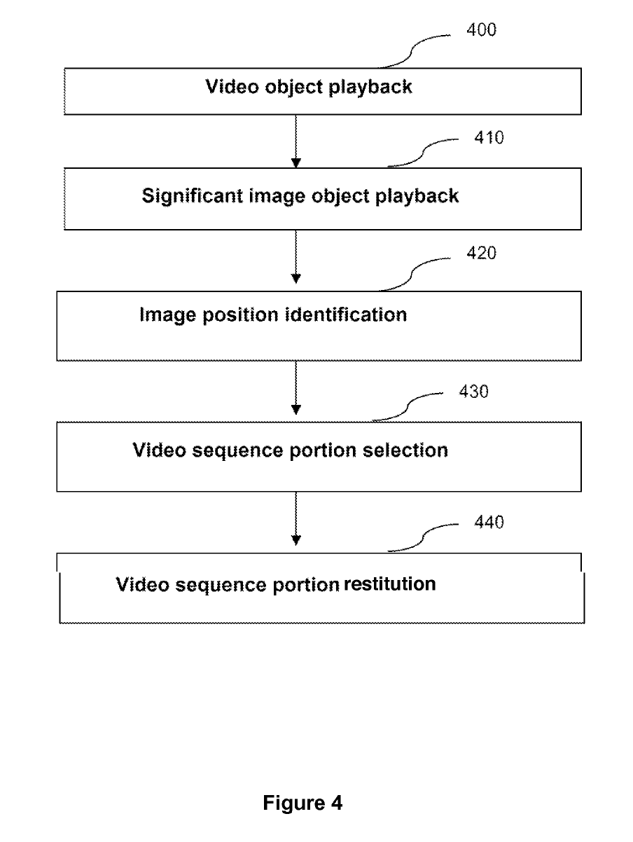

The viewing method according to an embodiment of the invention is described, illustrated by FIG. 4.

The method envisages a first step 400 for playing back a video type object, generated according to the storage method described above from a video sequence.

This step is followed by a step 410 for playing back a significant image type object, generated according to the storage method described above from an image obtained from the same video sequence.

According to an embodiment of the invention, the method then implements a step 420 for identifying the exact position of the image in the video sequence.

This step 420 is followed by a step 430 for selecting at least one portion of the video sequence.

The viewing method finally envisages a restitution step 440 of the video sequence portions selected in the previous step 430.

In one alternative embodiment of the viewing method described, the method may envisage that additional steps, similar to steps 212 to 240 of the storage method according to an embodiment of the invention (or a reiteration of these steps), are performed, during viewing, from said reproduced video sequence portion and said at least one significant image and the common synchronisation reference means thereof. This alternative embodiment thus makes it possible to modify the medical data associated with a significant image as it is viewed, for example with comments from different doctors, or in the course of a medical evaluation.

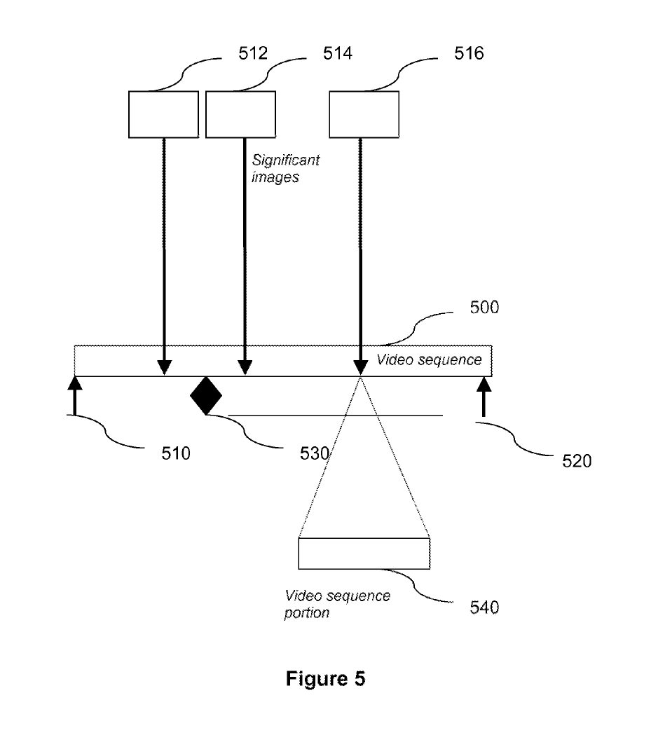

FIG. 5 illustrates a particular viewing mode of medical imaging information objects.

In this embodiment, the video sequence is viewed in a low definition quality.

The block diagram 500 represents the video sequence, the scale used being the video sequence start 510 and end 520 time indications.

Symbols represent significant images 512, 514 and 516 on this block diagram. The position of these symbols is dependent on the dating thereof.

A cursor 530 indicates the current position in the course of the video sequence 500.

In some embodiments, all the significant images are displayed automatically.

In further embodiments, this will consist of the nearest previous significant image 512, or the nearest following significant image 514 or one or a plurality significant images referenced by the user.

For example, if a user selects the symbol of a significant image 516, the significant image is displayed in High Definition format and the sequence viewed around the corresponding time.

According to the embodiments, the sequence may be viewed from the time corresponding to the significant image or shortly beforehand. It may also consist of a portion 540 of said video sequence wherein the start and end are directly linked with the referenced significant image 516, the time and time shift in relation to the significant image defined by configuration and/or set by the user.

### 3. Second Embodiment

According to a further embodiment, the synchronisation information 326 is not registered in the significant image object, but in an independent object, referred to as a selection object, containing at least, for a given video sequence, a list of the significant images identified therein, and at least one item of synchronisation information for rapid tagging of a significant image in the sequence.

It should be noted that, in DICOM, a “Key Object Selection” type object already exists. However, it is used for listing objects, but not for linking same together, using synchronisation information. In one particular embodiment, the invention proposes to modify the structure of said existing objects, to insert the synchronisation information according to an embodiment of the invention therein.

Some embodiments of the invention envisage transmission of medical imaging information objects relating to a video sequence in two steps.

Firstly, the significant image objects are sent to the viewing device as they are generated.

Secondly, the video object and the selection object are sent after all the significant image objects.

According to an alternative of this embodiment, the selection object may also contain all or part of the representative data of the synchronisation reference means associated with the video sequence.

At least one embodiment of the present disclosure improves the viewing and processing of medical video sequences associated with fixed images, referred to as significant images.

At least one embodiment simplifies the processing operations to be performed, for a user.

At least one embodiment enables a user wishing to view the results of a medical investigation to save time, by focusing rapidly and effectively on the important points of the investigation.

At least one embodiment provides such a technique which is simple and inexpensive to implement.

At least one embodiment enables easy local or remote sharing of the images and video generated.

Although the present disclosure has been described with reference to one or more examples, workers skilled in the art will recognize that changes may be made in form and detail without departing from the scope of the disclosure and/or the appended claims.

1. A method for storing medical data comprising at least one fixed image, referred to as a significant image, and a video sequence comprising a data stream for reconstructing a succession of images, said significant image corresponding to a specific time of said sequence, wherein the method comprises the following steps:
acquisition of said video sequence;
tagging of at least one significant image in said acquired video sequence;
acquisition of at least one traceability data item;
obtaining a common time synchronisation reference for said video sequence and each of said significant images;
determination of at least one item of time synchronisation information, representative of an exact position of said significant image in said video sequence, according to said synchronisation reference;
generation of at least two medical imaging information objects, according to a predetermined standard, comprising:
a first object, referred to as a video object, comprising at least said video sequence and a first set of data structured according to said standard comprising at least one medical traceability data item and representative data of said synchronisation reference, and
at least one second object, referred to as a significant image object, comprising one of said significant images and a second set of data structured according to said standard comprising at least said at least one medical traceability data item; and
storage of said medical imaging information objects and said time synchronisation information on a non-transitory computer-readable medium, to enable, during subsequent viewing, the location in said video sequence of the exact image of said sequence corresponding to one of said significant images, according to said synchronisation reference.

2. The method for storing data according to claim 1, wherein said second set of data also comprises at least one of said items of time synchronisation information.

3. The method for storing medical data according to claim 1, wherein the medical imaging information generation step comprises generation of at least one third object, referred to as a selection object, comprising a second set of data structured according to said standard, comprising an identifier of said video object and, for each of said significant image objects, an identifier of said significant image object and at least one of said corresponding time synchronisation information items.

4. The method for storing medical data according to claim 1, wherein said representative data of the synchronisation reference includes at least one item of information belonging to the group consisting of:
a time reference source;
a description of a time distribution protocol;
a time pulse inserted in the video signal;
date and time of acquisition start and end times of said video sequence;
an effective duration of said video sequence;
an acquisition rate of said video sequence;
an identifier of said video sequence, identifying said video sequence according to said standard in a unique manner,
a feature of the multiplex frame corresponding to said video sequence;
an identifier of the medical investigation for which said video sequence was acquired.

5. The method for storing medical data according to claim 1, wherein said time synchronisation information has a selected precision, in relation to an acquisition rate of said video sequence, so as to enable determination of the exact position of an image in said video sequence and belongs to the group consisting of:
time reference source;
a description of said time distribution protocol;
an identification of said video sequence according to said standard,
an indication of a frame number in the multiplex frame of said video sequence;
an index of said fixed image in said numbered frame;
date and time corresponding to an acquisition of said significant image;
an identifier of the medical investigation for which said significant image was acquired.

6. The method for storing medical data according to claim 1, wherein said acquisition and tagging steps of said significant image are implemented simultaneously.

7. The method for storing medical data according to claim 1, wherein the method comprises a compression step delivering a compressed video object with a lower definition quality than an initial quality of said acquired video sequence.

8. The method for storing medical data according to claim 1, wherein the method is based on Digital Imaging and Communications in Medicine (DICOM) format encoding.

9. The method for storing medical data according to claim 1, wherein the method comprises an additional synchronisation step of at least one of said medical imaging information objects with another medical imaging information object from another acquisition source than said video sequence.

10. A device for storing medical data comprising at least one fixed image, referred to as a significant image, and a video sequence comprising a data stream for reconstructing a succession of images, said significant image corresponding to a specific time in said sequence, wherein the device comprises:
acquisition means for acquiring said video sequence;
means for tagging at least one significant image in said acquired video sequence;
means for acquiring at least one traceability data item;
means for obtaining a common time synchronisation reference for said video sequence and each of said significant images;
means for determining at least one item of time synchronisation information, representative of an exact position of said significant image in said video sequence, according to said synchronisation reference;
means for generating at least two medical imaging information objects, according to a predetermined standard, comprising:
a first object, referred to as a video object, comprising at least said video sequence and a first set of data structured according to said standard comprising at least one medical traceability data items and representative data of said synchronisation reference, and
at least one second object, referred to as a significant image object, comprising one of said significant images and a second set of data structured according to said standard comprising at least said at least one medical traceability data item; and
means for storing said medical imaging information objects and said time synchronisation information, to enable, during subsequent viewing, the location in said video sequence of the exact image of said sequence corresponding to one of said significant images, according to said synchronisation reference.

11. A method for viewing medical data comprising at least one video sequence comprising a data stream for reconstructing a succession of images, and at least one significant image, said significant image corresponding to a specific time in said sequence, stored in the form of a first object, referred to as a video object and at least one second object, referred to as a significant image object,
wherein the video object comprises at least said video sequence and a first set of data structured according to a predetermined standard and comprising at least one medical traceability data item and representative data of a time synchronisation reference, said synchronisation reference being common for said video sequence and said significant image, and
wherein the significant image object comprises said significant image and a second set of data structured according to said standard and comprising at least said at least one medical traceability data item;
wherein the method comprises the following steps:
playback of said video object, to obtain said video sequence and said first set of data;
playback of said at least one significant image object, to obtain said significant image and said second set of data;
obtaining at least one item of time synchronisation data relating to said significant image;
identification of an exact position of said significant image in said video sequence using said item of synchronisation information and said synchronisation reference;
selection of a portion of said video sequence, comprising at least one image near said significant image, according to said traceability data of said second object; and
restitution of said significant image and said portion of said video sequence on a viewing device.

12. The method according to claim 11, wherein said restitution step further comprises restitution of said at least one medical traceability data item.

13. The method according to claim 11, wherein said restitution step includes criteria defined by configuration or manually belonging to the group consisting of:
viewing of all the significant images in said acquired video sequence;
viewing of each significant image with which a specific medical traceability data item is associated,
selection by a user of the significant images to be viewed;
dynamic restitution of said portion of said video sequence according to a time tagging thereof with respect to said significant image.

14. The method according to claim 13, wherein the dynamic restitution step uses at least one criterion defined by configuration or manually belonging to the group consisting of:
duration of said portion of said video sequence;
time interval between the start and/or end of said portion of said video sequence and the time tagging associated with said significant image;
memory size of said portion of said video sequence;
spatial resolution of said portion of said video sequence.

15. A device for viewing medical data comprising at least one video sequence consisting of a data stream for reconstructing a succession of images, and a significant image, said significant image corresponding to a specific time in said sequence, stored in the form of a first object, referred to as a video object and at least one second object, referred to as a significant image object,
wherein the video object comprises at least said video sequence and a first set of data structured according to a predetermined standard and comprising at least one medical traceability data item and representative data of a time synchronisation reference, said synchronisation reference being common for said video sequence and said significant image; and
wherein the significant image object comprises said significant image and a second set of data structured according to said standard and comprising at least said at least one medical traceability data item;
wherein the device comprises:
means for playing back said video object, to obtain said video sequence and said first set of data;
means for playing back at least one significant image object, to obtain said significant image and said second set of data;
means for obtaining at least one item of time synchronisation data relating to said significant image;
means for identifying an exact position of said significant image in said video sequence using said item of synchronisation information and said synchronisation reference means;
means for selecting a portion of said video sequence, comprising at least one image near said significant image, according to said traceability data of said second object; and
means for the restitution of said significant image and said portion of said video sequence.

16. A non-transitory computer-readable medium comprising program code instructions stored thereon which, when run on a computer, perform a method for storing medical data comprising at least one fixed image, referred to as a significant image, and a video sequence comprising a data stream for reconstructing a succession of images, said significant image corresponding to a specific time of said sequence, wherein the method comprises:
acquisition of said video sequence;
tagging of at least one significant image in said acquired video sequence;
acquisition of at least one traceability data item;
obtaining a common time synchronisation reference for said video sequence and each of said significant images;
determination of at least one item of time synchronisation information, representative of an exact position of said significant image in said video sequence, according to said synchronisation reference;
generation of at least two medical imaging information objects, according to a predetermined standard, comprising:
a first object, referred to as a video object, comprising at least said video sequence and a first set of data structured according to said standard comprising at least one medical traceability data item and representative data of said synchronisation reference, and
at least one second object, referred to as a significant image object, comprising one of said significant images and a second set of data structured according to said standard comprising at least said at least one medical traceability data item; and
storage of said medical imaging information objects and said time synchronisation information on a non-transitory computer-readable medium, to enable, during subsequent viewing, the location in said video sequence of the exact image of said sequence corresponding to one of said significant images, according to said synchronisation reference.

17. A non-transitory computer-readable medium comprising comprising program code instructions stored thereon which, when run on a computer, perform a method for viewing medical data comprising at least one video sequence comprising a data stream for reconstructing a succession of images, and at least one significant image, said significant image corresponding to a specific time in said sequence, stored in the form of a first object, referred to as a video object and at least one second object, referred to as a significant image object, and comprising at least one medical traceability data item, wherein the method comprises:
playback of said video object, to obtain said video sequence and a first set of data structured according to a predetermined standard comprising at least one medical traceability data item and representative data of a common synchronisation reference;
playback of said at least one significant image object, to obtain a significant image and a second set of data structured according to said standard comprising at least said at least one medical traceability data item;
obtaining at least one item of time synchronisation data relating to said significant image;
identification of an exact position of said significant image in said video sequence using said item of synchronisation information and said synchronisation reference;
selection of a portion of said video sequence, comprising at least one image near said significant image, according to said traceability data of said second object; and
restitution of said significant image and said portion of said video sequence on a viewing device.

18. (canceled)

19. (canceled)

20. (canceled)

21. (canceled)

22. (canceled)

23. (canceled)
